(19) United States
(12) Patent Application Publication
(10) Pub. No.: US 2024/0355531 A1
(43) Pub. Date: Oct. 24, 2024

(54) INDUCTIVE DEVICES AND ASSOCIATED METHODS FOR IMPROVED OVERCURRENT PERFORMANCE

(71) Applicant: ABB Schweiz AG, Baden (CH)

(72) Inventors: Harish Suryanarayana, Raleigh, NC (US); Dorai Yelaverthi, Raleigh, NC (US); Arun Kadavelugu, Raleigh, NC (US)

(21) Appl. No.: 18/304,152

(22) Filed: Apr. 20, 2023

(51) Int. Cl. H01F 27/28; H01F 27/26; H01F 41/02; H01F 41/04

(52) U.S. Cl. CPC H01F 27/2823; H01F 27/26; H01F 41/0206; H01F 41/04

(57) ABSTRACT

A device may include a core structure having low permeability characteristics and defining a first cross-sectional area, a coil member including one or more loops that winds around the core structure and defines a second cross-sectional area. The second cross-sectional area is between 1.2 to 5 times larger than the first cross-sectional area. The device may include a frame member positioned around the core structure or a portion thereof and the coil member may wind around the frame member to define the second cross-sectional area. The core structure may be composed of a low permeability magnetic material having a low relative permeability. The core structure may be composed of a high permeability magnetic material and the core structure may further include an air gap structure to enable the core structure to demonstrate the low permeability characteristics.

### FIELD

The present disclosure relates to the field of inductive devices, and specifically to improving overcurrent performance in inductive devices.

### BACKGROUND

Inductive devices typically include a core structure having a coil member wound around the core structure or a portion thereof. Many inductive devices are designed to maintain operation for a time period during overcurrent and fault conditions. Inductive devices achieve this by implementing high cost core materials with better saturation properties or to implement low relative permeability core materials, which require more material to obtain the same inductive performance. Another approach is to increase the number of loops formed by the coil member. This latter approach is utilized because the square of the number of windings is directly proportional to inductance. However, increasing the number of loops formed by the coil leads to increased material costs due to the additional winding material and from increasing the size of the core structure to accommodate the additional coil loops. Additionally, inductive device designs typically focus on reducing the physical dimensions of the inductive device by decreasing core size or by minimizing the size of the windings.

### SUMMARY

In some embodiments, a device includes a core structure having low permeability characteristics, the core structure defining a first cross-sectional area, and one or more coil members including one or more sets of loops, the one or more sets of loops winding around the core structure and defining a second cross-sectional area, the second cross-sectional area being between 1.2 to 5 times larger than the first cross-sectional area.

In some embodiments, a portion of the core structure defines the first cross-sectional area, and the one or more coil members wind around the portion of the core structure and defines the second cross-sectional area.

In some embodiments, the device further includes one or more frame members, the one or more frame members are located around the core structure, and wherein the one or more coil members wind around the one or more frame members to define the second cross-sectional area.

In some embodiments, the one or more frame members are located around a portion of the core structure.

In some embodiments, the core structure includes a toroidal core structure.

In some embodiments, the core structure includes a UU core structure including a first leg, and a second leg, and the one or more coil members wind around the first leg, the second leg, or both.

In some embodiments, the one or more coil members is further configured to provide an increase in inductance due to increased leakage paths for magnetic flux in response to increasing electrical current.

In some embodiments, the core structure is composed of a low permeability magnetic material having a relative permeability from 10 to 200 μr.

In some embodiments, the core structure is composed of a high permeability magnetic material and the core structure further includes an air gap structure to enable the device to demonstrate the low permeability characteristics.

In some embodiments, the one or more coil members includes at least one of a flat wire, a multistrand wire having individually insulated strands, and an insulated magnet wire.

In some embodiments, an inductive device includes a core structure having low permeability characteristics, the core structure defining a first cross-sectional area, one or more frame members, the one or more frame members is located around the core structure, and one or more coil members including one or more sets of loops, the one or more sets of loops winds around the one or more frame members and defines a second cross-sectional area, the second cross-sectional area is between 1.2 to 5 times larger than the first cross-sectional area.

In some embodiments, a portion of the core defines the first cross-sectional area, the one or more frame members is located around the portion of the core structure, and the coil member winds around the one or more frame members and defines the second cross-sectional area.

In some embodiments, the core structure includes a toroidal core structure.

In some embodiments, the core structure includes a UU core structure including a first leg, and a second leg, and the one or more frame members and the respective one or more coil members winds around the first leg, the second leg, or both.

In some embodiments, the one or more coil members is further configured to provide an increase in inductance due to increased leakage paths for magnetic flux in response to increasing electrical current.

In some embodiments, the core structure includes a low permeability magnetic material having a relative permeability from 10 to 200 μr, or a high permeability magnetic material and the core structure further includes an air gap structure to enable the core structure to demonstrate the low permeability characteristics.

In some embodiments, a method including obtaining a core structure having low permeability characteristics for an inductor, the core structure defining a first cross-sectional area, obtaining one or more coil members, and winding the one or more coil members around the core structure and forming one or more sets of loops, the one or more sets of loops each define a second cross-sectional area, the second cross-sectional area is between 1.2 to 5 times larger than the first cross-sectional area.

In some embodiments, winding the one or more coil members around the core structure includes winding the one or more coil members around a portion of the core structure.

In some embodiments, the method further includes obtaining one or more frame members, and positioning the one or more frame members around the core structure, the one or more coil members winds around a respective one of the one or more frame members to define the second cross-sectional area.

In some embodiments, the one or more coil members are further configured to provide an increase in inductance due to increased leakage paths for magnetic flux in response to increasing electrical current.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a perspective view of a device, according to some embodiments.

FIG. 2 is a top sectional view of the device, according to some embodiments.

FIG. 3 is a perspective view of the device, according to some embodiments.

FIG. 4 is a top sectional view of the device, according to some embodiments.

FIG. 5 is a perspective view of the device, according to some embodiments.

FIG. 6A is a top view of the device, according to some embodiments.

FIG. 6B is a second top view of the device, according to some embodiments.

FIG. 7A is a perspective view of a device, according to some embodiments.

FIG. 7B is a second perspective view of the device, according to some embodiments.

FIG. 8 is a first side view of the device, according to some embodiments.

FIG. 9 is a side sectional view of the device, according to some embodiments.

FIG. 10 is a second side view of the device, according to some embodiments.

FIG. 11 is a flow diagram of a method, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

When designing inductive devices for electronic applications such as, for example, an LC filter or fault current limiting device, a typical design limitation is the inductance during overcurrent conditions, fault conditions, or other high current transients. Accordingly, inductive devices are designed based on output voltage, current total harmonic distortion (“THD”), and maintaining sufficient inductance during over-current conditions to enable fault/overcurrent operation such as when current exceeds nominal current by 1.5 to 5 times normal values. For certain applications, e.g., SiC MOSFET and GaN based power converters, the inductance required during overcurrent or fault conditions is a bottleneck in inductor design because these converters operate at higher switching frequencies (10 kHz and higher) compared to converters with lower switching frequencies such as Si-IGBT converters.

To provide gradually decreasing inductance during overcurrent/fault conditions and for applications with high switching frequencies, inductors typically include a core structure formed of soft saturating low permeability magnetic materials, such as powder core, or the like. Alternatively, inductive devices can increase the number of loops in the core and formed by the coil member to provide increased inductance. However, to minimize the total physical dimensions of the inductive device, the coil member is typically wound directly around the core structure, or a portion thereof, such that the cross-sectional area defined by the winding loop is similar to the cross-sectional area of the core structure around which the coil member is wound. For example, the winding is wound around the core structure such that the core provides support for the windings. In other inductive devices, the core structure may be formed from high permeability core materials such as ferrite or magnetic steel, but the core structure using these types of materials typically include an air gap in the core to provide the desired operational characteristics.

Various embodiments described herein relate to an inductive device or system and associated method for forming said inductive device capable of maintaining inductance during overcurrent or fault conditions by providing a core structure including a coil member having a cross-sectional area that is greater than the core structure, or portion thereof, around which the coil member is wound. For example, the inductive device is capable of maintaining inductance for a certain time period when the electrical current exceeds nominal current by 1.5 to 5 times normal values in a power converter configured to operate at switching frequencies of 10 kHz and higher. The inductive device includes a core structure that provides low permeability and soft saturation characteristics, thereby demonstrating gradually decreasing inductance in response to increasing electrical current. In some embodiments, the core structure may be formed of low permeability magnetic materials. For example, the core structure may include powder core. In other embodiments, the core structure may instead be formed of high permeability magnetic materials and the core structure may include an air gap defined by the core structure to provide the low permeability characteristics. For example, the core structure may be formed of ferrite. It is to be appreciated by those having ordinary skill in the art that the type of core material is not intended to be limiting and may include any of a plurality of magnetic materials used in inductors, in accordance with this disclosure.

The inductive device also includes a coil member. The coil member is wound around the core structure and the winding defines a cross-sectional area that is greater than a cross-sectional area of the core structure around which the winding is located, as will be further described herein. In this regard, the inductive device described herein is capable of providing higher inductance in response to increasing current when compared to an inductive device where the coil member is wound directly around the core structure such that the cross-sectional area defined by the windings is substantially similar to the cross-sectional area of the core structure around which the coil member is wound.

The various embodiments described herein leverage the increased cross-sectional area defined by the one or more loops (e.g., the windings) compared to the cross-sectional area of the core structure to provide increased inductance. Accordingly, this winding design provides a solution for obtaining higher inductance during overcurrent conditions rather than by increasing the amount of core materials used in the device. Accordingly, the various embodiments described herein provide a simplified approach for providing improved inductor performance in response to increasing electrical current while maintaining reduced costs compared to other techniques that provide a similar effect by implementing higher cost core materials or by increasing the size of the core structure. Additionally, the inductive device described herein can provide improved cooling capabilities for both the windings and the core. Furthermore, the winding arrangement can also provide an additional degree of design freedom to meet the minimum inductance criteria at both nominal and overcurrent conditions.

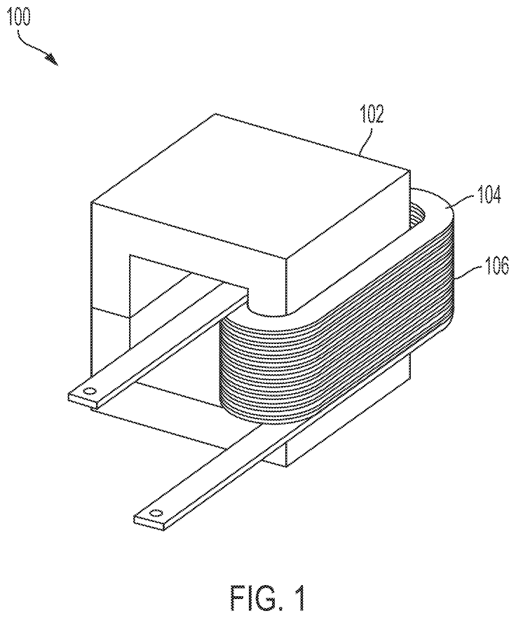

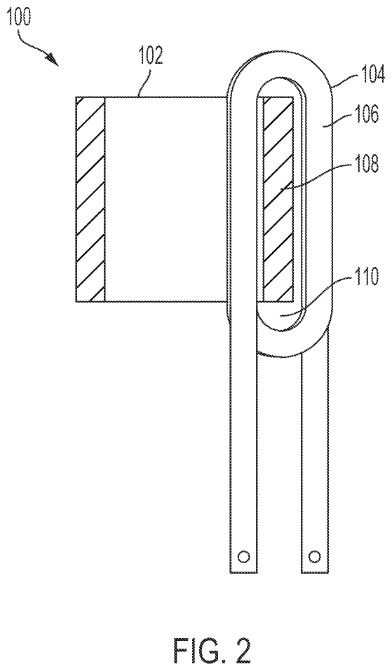

FIG. 1 illustrates a perspective view of a non-limiting example of a device 100, according to some embodiments. FIG. 2 illustrates a top view of the device 100, according to some embodiments. Unless specifically referenced, FIGS. 1 and 2 will be described collectively.

The device 100 includes a core structure 102 and a coil member 104. The core structure 102 may be configured to demonstrates low permeability characteristics to enable the device 100 to maintain operation during overcurrent and fault conditions. The core structure 102 may be formed of one or more magnetic materials to concentrate and contain a magnetic flux. The coil member 104 is an elongate electrically conductive member configured to be wound around the core structure 102, or a portion thereof, and thereby form a set of loops 106 (e.g., coils, spirals, etc.). The coil member 104 is also configured to produce an electromagnetic field in response to an electrical current directed through the coil member 104. Accordingly, in some embodiments, the ends of the coil member 104 may be placed in electrical connection with a power source or other electronic component(s) capable of passing an electrical current through the coil member 104 to generate the electromagnetic field.

In some embodiments, the core structure 102 may be formed from one or more magnetic materials having a low relative permeability. In some embodiments, the core structure 102 may be formed from magnetic materials having low relative permeability between 10 to 200 μᵣ. For example, the core structure 102 may be formed from powder core materials. In other embodiments, the core structure 102 may be formed from magnetic materials having a high relative permeability, as compared to soft-saturating core materials, and the core structure 102 may include an air gap structure configured to enable the device to demonstrate and provide the low permeability characteristics. For example, the core structure 102 may be formed from ferrite, magnetic steel, Nickel, Cobalt, alloys thereof, or any combinations thereof. It is to be appreciated by those having ordinary skill in the art that the magnetic materials in the core structure 102 are not intended to be limiting and may include any of a plurality of materials including, but not limited to, high permeability magnetic materials, low permeability magnetic materials, binders, thermoplastics, fillers, other materials, or any combinations thereof, to enable the device 100 in accordance with this disclosure. Furthermore, it is to be appreciated by those having ordinary skill in the art that the configuration of the core structure 102 (e.g., core type) is exemplary and not intended to be limiting. Accordingly, the core structure 102 may be any of a plurality of core configurations including, but not limited to, C type, UU type, EE type, EI type, EC type, ETD type, ER type, EFD type, EPC type, PQ type, RM type, DS type, toroidal type, other types, or any combinations thereof, in accordance with this disclosure.

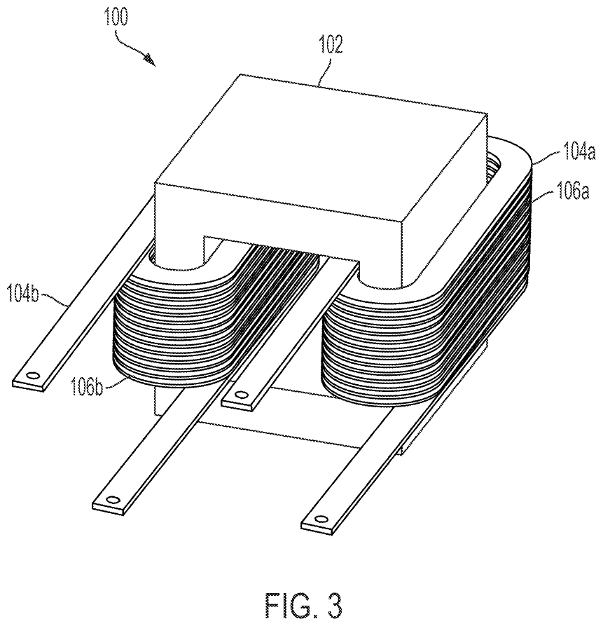

The coil member 104 winds around core structure 102 and forms a set of loops 106. In some embodiments, the coil member 104 may wind around a portion of the core structure 102. In some embodiments, the coil member 104 may extend through the core structure 102 and around a portion of the core structure 102. In some embodiments, as shown in FIG. 1, the core structure 102 may include a first leg and a second leg. Accordingly, in some embodiments, the coil member 104 may wind around the first leg, the second leg, or both. For example, in some embodiments, the core structure 102 may be a UU-type core having four sides and the coil member 104 winds around one of the sides (e.g., leg). In some embodiments, and as shown in FIG. 3, the device 100 may include more than one coil member 104 that winds around one or more sides of the core structure 102, as will be further described herein.

Referring to FIG. 2, the cross-sectional area defined by the core structure 102 is a first cross-sectional area 108 and the cross-sectional area defined by the set of loops 106 is a second cross-sectional area 110. The second cross-sectional area 110 defined by the set of loops 106 of the coil member 104 and is greater than the first cross-sectional area 108 defined by the core structure 102, or portion thereof, that is located between the set of loops 106 of the coil member 104. In some embodiments, the second cross-sectional area 110 is defined by an internal circumference of the set of loops 106, e.g., the opening formed by the set of loops 106. In other embodiments, the cross-sectional area of the coil member 104 may be defined by an external circumference of the set of loops 106.

In some embodiments, the second cross-sectional area 110 is greater than the first cross-sectional area 108. In some embodiments, the second cross-sectional area may be 1.2 to 5 times larger than the first cross-sectional area, or any range or subrange therebetween. In some embodiments, the second cross-sectional area may be 1.5 to 5 times larger than the first cross-sectional area. In some embodiments, the second cross-sectional area may be 1.8 to 5 times larger than the first cross-sectional area. In some embodiments, the second cross-sectional area may be 2 to 5 times larger than the first cross-sectional area. In some embodiments, the second cross-sectional area may be 2.3 to 5 times larger than the first cross-sectional area. In some embodiments, the second cross-sectional area may be 2.5 to 5 times larger than the first cross-sectional area. In some embodiments, the second cross-sectional area may be 3 to 5 times larger than the first cross-sectional area. In some embodiments, the second cross-sectional area may be 3.5 to 5 times larger than the first cross-sectional area. In some embodiments, the second cross-sectional area may be 4 to 5 times larger than the first cross-sectional area. In some embodiments, the second cross-sectional area may be 4.5 to 5 times larger than the first cross-sectional area.

The size and dimensions of the coil member 104 may vary based on a desired operational characteristics of the device 100. For example, in some embodiments, a width and length of the coil member 104 may be based on any of a plurality of factors including, but not limited to, a size of the core structure 102, size of the frame member 112, total dimensions of the device 100, the inductance characteristics, the number of loops, other factors, or any combinations thereof. The coil member 104 may also be formed from one or more elongate segments joined together to form the coil member 104. For example, the coil member 104 may include two elongate segments of electrical conductor welded together. It is to be appreciated that the size and dimensions of the coil member 104 is not intended to be limiting and may include any of a plurality of dimensions in accordance with this disclosure.

In some embodiments, the coil member 104 may be at least one of a flat wire, a multistrand wire, a magnet wire, or a combination thereof. In some embodiments, the coil member 104 may be a flat wire. In other embodiments, the coil member 104 may be round wire or a rounded wire. In some embodiments, the coil member 104 may be a multistrand wire (e.g., Litz wire). In some embodiments, the multistrand wire may include one or more individually insulated strands. In some embodiments, the coil member 104 may be a magnet wire. In some embodiments, the magnet wire may include an insulative coating (e.g., enameled coating) applied to an exterior of the wire.

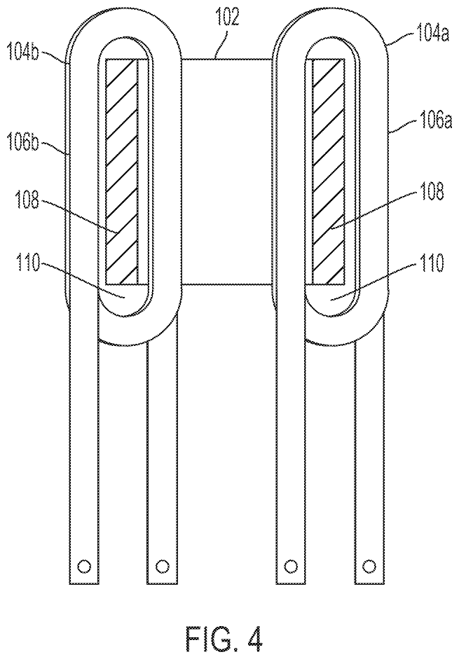

FIG. 3 is a perspective view of another non-limiting example of the device 100, according to some embodiments. FIG. 4 is a top view of the device 100 of FIG. 3, according to some embodiments. Unless specifically referenced, FIGS. 3 and 4 will be described collectively.

The device 100 may include one or more of the coil member 104 that each form a set of loops 106 around the core structure 102. In this regard, the device 100 may include coil member 104a wound around a first leg of the core structure 102 and coil member 104b wound around a second leg of core structure 102. Accordingly, the coil member 104a forms a set of loops 106a and the coil member 104b forms a set of loops 106b around the core structure 102.

Furthermore, although not shown in the figures, the device 100 may include more than two coil members that wind around the core structure 102. For example, in some embodiments, for a UU-type core structure, for each respective side of the core structure 102, the core structure 102 may include a coil member 104 positioned around each respective side, thereby forming four sets of loops and where one or more of the four sets of loops has a cross-sectional area that is greater than the cross-sectional area of the respective core structure 102, or portion thereof.

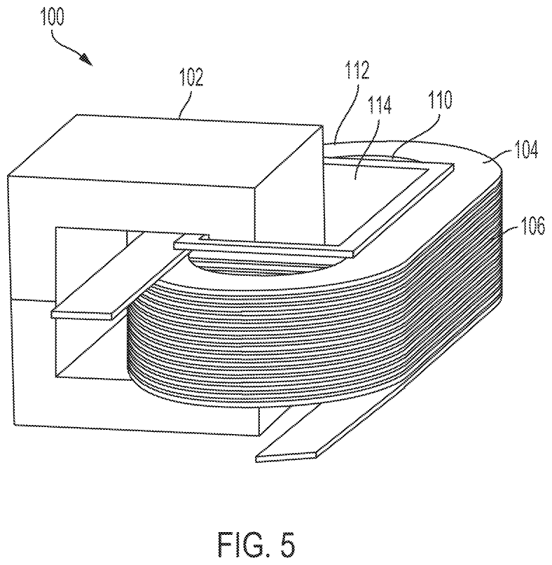

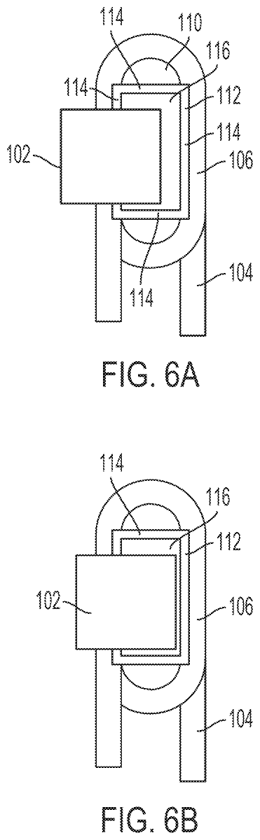

FIG. 5 is a perspective view of the device 100, according to some embodiments. FIG. 6A is a top view of another non-limiting example of a device 100, according to some embodiments. FIG. 6B is a second top view of the device 100, according to some embodiments. Unless specifically referenced, FIGS. 4-6 will be described collectively.

The device 100 may further include a frame member 112 having at least one sidewall 114 that defines an opening extending therethrough. The frame member 112 may substantially surround the core structure 102, or a portion thereof. In this regard, the core structure 102, or a portion thereof, may therefore extend through the opening of the frame member 112. For example, the core structure 102 may be a UU-type core and the frame member 112 may be positioned to substantially surround one of the legs of the core structure 102. In some embodiments, the frame member 112 may include a flange located at distal ends of the frame member 112 and the coil member 104 may be wound around the frame member 112 between the flanges.

In some embodiments, the frame member 112 may be a cylindrically shaped member. For example, the frame member 112 may be a bobbin. In some embodiments, the frame member 112 may include more than one sidewall 114. For example, the frame member 112 may have a rectangular shaped cross-section defined by four sides. In another example, the frame member 112 may comprise a polygonal shaped cross-section where each side is formed from sidewall 114. It is to be appreciated by those having ordinary skill in the art that the size and dimensions of the frame member 112 is not intended to be limiting and may include any combination of shapes and dimensions such that the frame member may be positioned around the core structure 102, or a portion thereof, and the coil member 104 may be wound around the frame member 112 to have a cross-sectional area larger than the core structure 102 located within the frame member 112. It is also to be appreciated by those having ordinary skill in the art that the number of sides of the frame member 112 is not intended to be limiting and may include any number of sides in accordance with this disclosure.

The coil member 104 winds around the frame member 112. The coil member 104 winds around a perimeter of the frame member 112 to form the set of loops 106 that define the second cross-sectional area 110. Accordingly, the second cross-sectional area 110 may also be defined, at least in part, by the perimeter (e.g., circumference) of the frame member 112.

In some embodiments, the second cross-sectional area 110 may also be greater than the perimeter of the frame member 112. For certain types of coils (e.g., flat wire), as the coil member 104 winds around the frame member 112, the coil member 104 may not conform exactly with the perimeter of the frame member 112. In this regard, in some embodiments, the cross-sectional area of the coil member 104 may be larger than the cross-sectional area defined by the perimeter of the frame member 112 due to the coil member 104 looping around to form the set of loops 106 around the frame member 112. Accordingly, as shown in FIG. 5, the set of loops 106 may substantially conform to the frame member 112 on two of the sides but may not conform to the frame member 112 on the other two sides depending on the characteristics of the coil member 104. Accordingly, in some embodiments, the frame member 112 may include appropriate dimensions to enable the second cross-sectional area 110 of the coil member 104 to be between 1.2 and 5 times greater than the cross-sectional area of the core structure 102 based on the desired inductance characteristics and other factors in accordance with this disclosure.

The frame member 112 may define a third cross-sectional area 116. The third cross-sectional area 116 may be defined by the at least one sidewall 114. The third cross-sectional area 116 is greater than an area of the portion of the core structure 102 the frame member 112 extends around. In some embodiments, the third cross-sectional area 116 may be greater than the first cross-sectional area 108. Additionally, in some embodiments, the second cross-sectional area 110 may be greater than the third cross-sectional area 116. In other embodiments, second cross-sectional area 110 may be substantially similar to the third cross-sectional area 116. For example, when the coil member 104 is wound directly around the frame member 112.

The frame member 112 may be positioned relative to the core structure 102 based on one or more parameters. In some embodiments, the position of the frame member 112 relative to the core structure 102 may be based on a desired magnetic flux density. In other embodiments, the position of the frame member 112 relative to the core structure 102 may be based on a design parameter (e.g., physical design characteristics).

Referring to FIG. 6A, the core structure 102 may extend through a central section of the opening defined by the at least one sidewall 114 of the frame member 112. Referring to FIG. 6B, the core structure 102 may extend through a lateral side of the opening of the frame member 112 such that the portion of the core structure 102 is located adjacent one of the sidewall 114. It is to be appreciated that the position of the frame member 112 relative to the core structure 102 is not intended to be limiting and may include any of a plurality of positions in accordance with this disclosure.

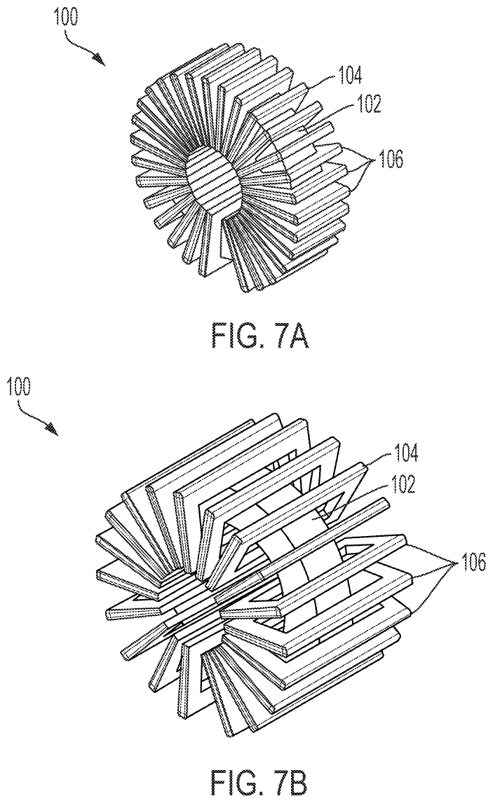

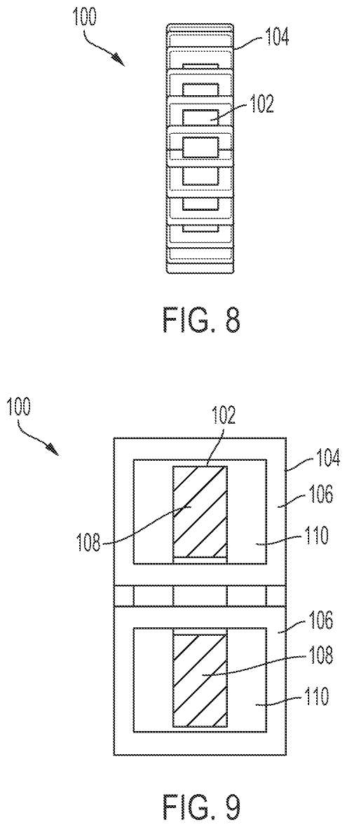

FIG. 7A is a first perspective view of another non-limiting example of a device 100, according to some embodiments. FIG. 7B is a second perspective view of the device 100, according to some embodiments. FIG. 8 is a side view of the device 100, according to some embodiments. Unless specifically referenced, FIGS. 7A-8 will be described collectively.

In some embodiments, a body of the core structure 102 may be a cylindrically shaped body. In some embodiments, the core structure 102 may include an opening (e.g., bore) extending therethrough. Additionally, the coil member 104 may circumferentially wind around the core structure 102 in a radial direction. In some embodiments, the coil member 104 may wind around the core structure 102 such that the coil member 104 extends through the opening, around an exterior of the portion of the core structure 102, and back through the opening in a radial direction until the coil member 104 circumferentially winds around the core structure 102. In this regard, the set of loops 106 are formed by the coil member 104 circumferentially extending around the core structure 102 such that each loop of the set of loops 106 radially extends through around the core structure 102 and by radially extending through the opening defined by the core structure 102. In some embodiments, the core structure 102 may be a toroidally shaped core.

In some embodiments, the frame member 112 may be a cylindrically shaped member that is positioned between the core structure 102 and the coil member 104 to enable the coil member 104 to extend around the core structure 102. Although not shown in the figures, in some embodiments, the frame member 112 may also radially extend around the core structure 102 and through the opening of the core structure 102 and may axially extend along the circumference of the core structure 102. Accordingly, in some embodiments, the coil member 104 may radially wind around the frame member 112 to enable the coil member 104 to maintain a cross-sectional area that is larger than the cross-sectional area of the core structure 102, or portion thereof of the core structure 102 around which the loop is formed. Stated another way, the core structure 102 may be located within a circumferential channel defined by the frame member 112 and the coil member 104 may radially extend around the frame member 112 to form the set of loops 106.

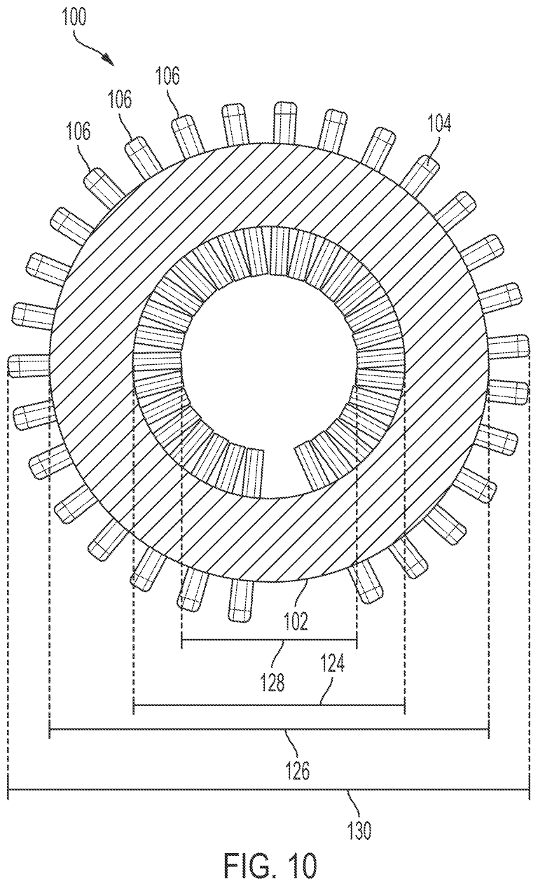

FIG. 9 is a first side sectional view of the device 100, according to some embodiments. FIG. 10 is a second side sectional view of the device 100, according to some embodiments. Unless specifically referenced, FIGS. 9-10 will be described collectively.

Referring to FIG. 9, the coil member 104 circumferentially extends around the core structure 102, where the second cross-sectional area 110 defined by the coil member 104 is larger than the first cross-sectional area 108 of the core structure 102, or portions thereof. Accordingly, the second cross-sectional area 110 defined by the coil member 104 may be 1.2 to 5 times larger than the first cross-sectional area 108 of the respective portion of the core structure 102. In this regard, a cross-section view of the device 100 would reveal a radially extending gap between the core structure 102 and the coil member 104 which circumferentially extends around the core structure 102 in an axial direction.

Referring to FIG. 10, the core structure 102 may be defined by a first diameter 124 and a second diameter 126. The first diameter 124 is a diameter of the opening (inner diameter) extending through the core structure 102. The second diameter 126 is an outer diameter of the core structure 102. In this regard, the first diameter 124 is smaller than the second diameter 126. Additionally, the coil member 104 may be defined by a third diameter 128 and a fourth diameter 130. The third diameter 128 is an inner diameter of the coil member 104 and the fourth diameter 130 is an outer diameter of the coil member 104. In this regard, the third diameter 128 is smaller than the fourth diameter 130. As shown in FIG. 9, the third diameter 128 may also be smaller than the first diameter 124 as the coil member 104 extends through the opening of the core structure 102. Also, the second diameter 126 may be smaller than the fourth diameter 130 as the coil member 104 extends around the outer perimeter of the core structure 102.

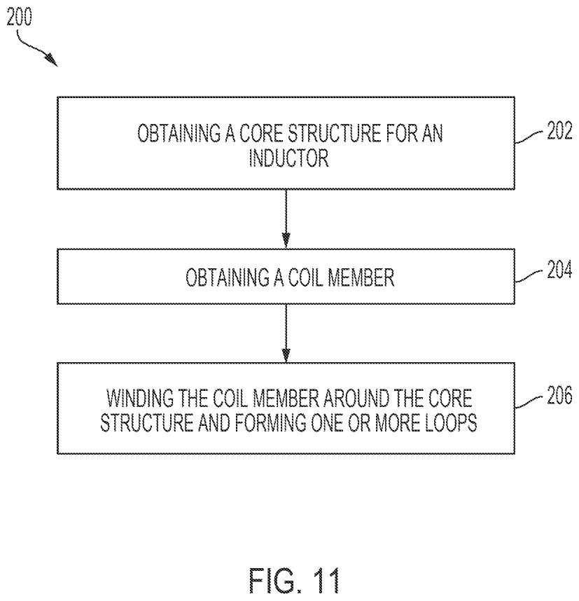

FIG. 11 illustrates a flow diagram of a method 200, according to some embodiments. At 202, the method 200 includes obtaining a core structure 102 for an inductor. The core structure 102 may be formed from magnetic materials having low permeability characteristics. The core structure 102 may concentrate and contain a magnetic flux that results in response to an electromagnetic field. The core structure 102 may be formed from one or more magnetic materials. In some embodiments, the core structure 102 may include magnetic materials having a low relative permeability ranging from 10 to 200 μr. In some embodiments, the core structure 102 may be composed of a magnetic material having high relative permeability and the core structure 102 further includes an air gap structure to enable the device to demonstrate the low permeability characteristics. In some embodiments, the core structure 102 may be a cylindrically shaped core body. In other embodiments, the core structure 102 may be a toroidally shaped cylindrical core structure. In some embodiments, the core structure 102 may be a UU shaped core structure.

At 204, the method 200 includes obtaining a coil member 104. In some embodiments, the method 200 may include obtaining one or more coil members 104. In some embodiments, the coil member 104 may be an elongate electrically conductive element. In some embodiments, the coil member 104 may be a substantially flat conductive element. In other embodiments, the coil member 104 may be a round conductive element. In some embodiments, the coil member 104 may include rounded edges. In some embodiments, the coil member 104 may be a copper wire. It is to be appreciated by those having skill in the art that the dimensions of the winding element are not intended to be limiting and may include any of a plurality of dimensions in accordance with this disclosure. It is to be appreciated by those having ordinary skill in the art that the materials that form the coil member 104 is not intended to be limiting and may include any of a plurality of materials in accordance with this disclosure.

At 206, the method 200 includes winding the coil member 104 around the core structure 102 and forming a set of loops 106. In some embodiments, the number of loops formed from the coil member 104 may vary based on a length of the coil member 104. In some embodiments, number of loops may vary based on a desired operational characteristic (e.g., inductance) of the device 100. In some embodiments, the coil member 104 is wound around the core structure 102 such that the coil member 104 defines a second cross-sectional area 110. In some embodiments, the coil member 104 is wound around the core structure 102, or a portion thereof, such that the second cross-sectional area 110 formed by the coil member 104 is larger than a first cross-sectional area 108 defined by the core structure 102, or a portion thereof located between the set of loops 106. For example, the coil member 104 may extend around an outer perimeter of the core structure 102. In another example, the core structure 102 may be a UU core and the coil member 104 may extend around the first leg of the core structure 102.

Additionally, in some embodiments, the second cross-sectional area 110 includes an area between 1.2 to 5 times larger than the first cross-sectional area 108. For example, the first cross-sectional area 108 defined by the portion of the core structure 102 may be 8 mm² and the second cross-sectional area 110 defined by the coil member 104 may be 15 mm². In some embodiments, the increased cross-sectional area of the coil member 104 compared to the cross-sectional area of the core structure 102 may be further configured to provide an increased inductance due to increased leakage paths for magnetic flux in response to increasing electrical current in the coil member 104.

In some embodiments, the method 200 may include winding the one or more coil members 104 around the core structure 102 and forming one or more sets of loops 106. In some embodiments, winding the one or more coil members 104 around the core structure 102 includes winding each of the one or more of the coil member 104 around a portion of the core structure 102. The one or more of the set of loops 106 each define a second cross-sectional area 110, where each second cross-sectional area 110 is larger than the first cross-sectional area 108 of the portion of the core structure 102. In some embodiments, each second cross-sectional area 110 is from 1.2 to 5 times larger than the first cross-sectional area 108 of the portion of the core structure 102.

In some embodiments, the method 200 further including obtaining a frame member 112. In some embodiments, the frame member 112 may be configured to extend around the core structure 102. In other embodiments, the frame member 112 may be configured to extend around a portion of the core structure 102. Accordingly, in some embodiments, the frame member 112 may include an opening extending through the frame member 112 and defined by the at least one sidewall 114 of the frame member 112. In some embodiments, the method 200 further includes positioning the frame member 112 around the core structure 102. In some embodiments, the frame member 112 may also be positioned to extend through the core structure 102. For example, the core structure 102 may be a UU core and the frame member 112 may be positioned around the first leg. In another example, the core structure 102 may be a toroidally shaped core including a bore extending therethrough and the frame member 112 may circumferentially extend around the toroidally shaped core in a radial direction, thereby defining a circumferential inner channel through which the core structure 102 is located. In some embodiments, the set of loops 106 of the coil member 104 may be formed around the frame member 112. In some embodiments, the frame member 112 may define, at least in part, the second cross-sectional area 110 of the set of loops 106.

In some embodiments, the method 200 includes obtaining one or more frame member 112. In some embodiments, the method 200 also includes positioning the one or more frame member 112 around the core structure 102. In some embodiments, each frame member 112 is positioned around a portion of the core structure 102. Additionally, the device 100 may include one or more of the coil member 104, where each of the one or more of the coil member 104 winds around a respective one of the one or more frame member 112 to define the second cross-sectional area 110.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “low permeability characteristic” refers to the saturation properties of the core. Specifically, where the core demonstrates soft saturation properties in response to an increasing electromagnetic field and where the inductance of an inductive device having a core with low permeability characteristics demonstrates gradually decreasing inductance in response to increasing electrical current, such as during overcurrent and/or fault conditions, as opposed to abrupt saturation properties where there is a sudden drop-off in inductance in response to increasing electrical current.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be:
disposed directly between both of the two other structural elements such that the particular structural component is in direct contact with both of the two other structural elements;
disposed directly next to only one of the two other structural elements such that the particular structural component is in direct contact with only one of the two other structural elements;
disposed indirectly next to only one of the two other structural elements such that the particular structural component is not in direct contact with only one of the two other structural elements, and there is another element which juxtaposes the particular structural component and the one of the two other structural elements;
disposed indirectly between both of the two other structural elements such that the particular structural component is not in direct contact with both of the two other structural elements, and other features can be disposed therebetween; or any combination(s) thereof.

As used herein “embedded” means that a first material is distributed throughout a second material.

### ASPECTS

Various Aspects are described below. It is to be understood that any one or more of the features recited in the following Aspect(s) can be combined with any one or more other Aspect(s).

Aspect 1. A device comprising: a core structure having low permeability characteristics, wherein the core structure defines a first cross-sectional area; and one or more coil members comprising: one or more sets of loops, wherein the one or more sets of loops winds around the core structure and defines a second cross-sectional area; wherein the second cross-sectional area is between 1.2 to 5 times larger than the first cross-sectional area.

Aspect 2. The device according to aspect 1, wherein a portion of the core structure defines the first cross-sectional area; and wherein the one or more coil members wind around the portion of the core structure and defines the second cross-sectional area.

Aspect 3. The device according to any of the preceding aspects, further comprising: one or more frame members, wherein the one or more frame members are located around the core structure; and wherein the one or more coil members wind around the one or more frame members to define the second cross-sectional area.

Aspect 4. The device according to aspect 3, wherein the one or more frame members are located around a portion of the core structure.

Aspect 5. The device according to any of the preceding aspects, wherein the core structure comprises a toroidal core structure.

Aspect 6. The device according to any of the preceding aspects, wherein the core structure comprises a UU core structure comprising: a first leg, and a second leg; and wherein the one or more coil members wind around the first leg, the second leg, or both.

Aspect 7. The device according to any of the preceding aspects, wherein the one or more coil members is further configured to provide an increase in inductance due to increased leakage paths for magnetic flux in response to increasing electrical current.

Aspect 8. The device according to any of the preceding aspects, wherein the core structure is composed of a low permeability magnetic material having a relative permeability from 10 to 200 μr.

Aspect 9. The device according to any of the preceding aspects, wherein the core structure is composed of a high permeability magnetic material and the core structure further comprises an air gap structure to enable the device to demonstrate the low permeability characteristics.

Aspect 10. The device according to any of the preceding aspects, wherein the one or more coil members comprises at least one of: a flat wire, a multistrand wire having individually insulated strands, and an insulated magnet wire.

Aspect 11. An inductive device comprising: a core structure having low permeability characteristics, wherein the core structure defines a first cross-sectional area; one or more frame members, wherein the one or more frame members is located around the core structure; and one or more coil members comprising: one or more sets of loops, wherein the one or more sets of loops winds around the one or more frame members and defines a second cross-sectional area; wherein the second cross-sectional area is between 1.2 to 5 times larger than the first cross-sectional area.

Aspect 12. The inductive device according to aspect 11, wherein a portion of the core defines the first cross-sectional area; wherein the one or more frame members is located around the portion of the core structure; and wherein the coil member winds around the one or more frame members and defines the second cross-sectional area.

Aspect 13. The inductive device according to aspects 11 or 12, wherein the core structure comprises a toroidal core structure.

Aspect 14. The inductive device according to aspects 11, 12, or 13, wherein the core structure comprises a UU core structure comprising: a first leg, and a second leg; and wherein the one or more frame members and the respective one or more coil members winds around the first leg, the second leg, or both.

Aspect 15. The inductive device according to aspects 11, 12, 13, or 14, wherein the one or more coil members is further configured to provide an increase in inductance due to increased leakage paths for magnetic flux in response to increasing electrical current.

Aspect 16. The inductive device according to aspects 11, 12, 13, 14, or 15, wherein the core structure comprises: a low permeability magnetic material having a relative permeability from 10 to 200 μr; or a high permeability magnetic material and the core structure further comprises an air gap structure to enable the core structure to demonstrate the low permeability characteristics.

Aspect 17. A method comprising: obtaining a core structure having low permeability characteristics for an inductor, wherein the core structure defines a first cross-sectional area; obtaining one or more coil members; and winding the one or more coil members around the core structure and forming one or more sets of loops, wherein the one or more sets of loops each define a second cross-sectional area; wherein the second cross-sectional area is between 1.2 to 5 times larger than the first cross-sectional area.

Aspect 18. The method according to aspect 17, wherein winding the one or more coil members around the core structure comprises: winding the one or more coil members around a portion of the core structure.

Aspect 19. The method according to aspects 17 or 18, further comprising: obtaining one or more frame members; and positioning the one or more frame members around the core structure; wherein the one or more coil members winds around a respective one of the one or more frame members to define the second cross-sectional area.

Aspect 20. The method according to aspects 17, 18, or 19, wherein the one or more coil members are further configured to provide an increase in inductance due to increased leakage paths for magnetic flux in response to increasing electrical current.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A device comprising:
a core structure having low permeability characteristics,
wherein the core structure defines a first cross-sectional area; and
one or more coil members comprising:
one or more sets of loops,
wherein the one or more sets of loops winds around the core structure and defines a second cross-sectional area;
wherein the second cross-sectional area is between 1.2 to 5 times larger than the first cross-sectional area.

2. The device of claim 1, wherein a portion of the core structure defines the first cross-sectional area; and
wherein the one or more coil members wind around the portion of the core structure and defines the second cross-sectional area.

3. The device of claim 1, further comprising:
one or more frame members,
wherein the one or more frame members are located around the core structure; and
wherein the one or more coil members wind around the one or more frame members to define the second cross-sectional area.

4. The device of claim 3, wherein the one or more frame members are located around a portion of the core structure.

5. The device of claim 1, wherein the core structure comprises a toroidal core structure.

6. The device of claim 1, wherein the core structure comprises a UU core structure comprising:
a first leg, and
a second leg; and
wherein the one or more coil members wind around the first leg, the second leg, or both.

7. The device of claim 1, wherein the one or more coil members is further configured to provide an increase in inductance due to increased leakage paths for magnetic flux in response to increasing electrical current.

8. The device of claim 1, wherein the core structure is composed of a low permeability magnetic material having a relative permeability from 10 to 200 μᵣ.

9. The device of claim 1, wherein the core structure is composed of a high permeability magnetic material and the core structure further comprises an air gap structure to enable the device to demonstrate the low permeability characteristics.

10. The device of claim 1, wherein the one or more coil members comprises at least one of:
a flat wire,
a multistrand wire having individually insulated strands, and
an insulated magnet wire.

11. An inductive device comprising:
a core structure having low permeability characteristics,
wherein the core structure defines a first cross-sectional area;
one or more frame members,
wherein the one or more frame members is located around the core structure; and
one or more coil members comprising:
one or more sets of loops,
wherein the one or more sets of loops winds around the one or more frame members and defines a second cross-sectional area;
wherein the second cross-sectional area is between 1.2 to 5 times larger than the first cross-sectional area.

12. The inductive device of claim 11, wherein a portion of the core structure defines the first cross-sectional area;
wherein the one or more frame members is located around the portion of the core structure; and
wherein the coil member winds around the one or more frame members and defines the second cross-sectional area.

13. The inductive device of claim 11, wherein the core structure comprises a toroidal core structure.

14. The inductive device of claim 11, wherein the core structure comprises a UU core structure comprising:
a first leg, and
a second leg; and
wherein the one or more frame members and a respective one or more coil members winds around the first leg, the second leg, or both.

15. The inductive device of claim 11, wherein the one or more coil members is further configured to provide an increase in inductance due to increased leakage paths for magnetic flux in response to increasing electrical current.

16. The inductive device of claim 11, wherein the core structure comprises:
a low permeability magnetic material having a relative permeability from 10 to 200 μᵣ; or
a high permeability magnetic material and the core structure further comprises an air gap structure to enable the core structure to demonstrate the low permeability characteristics.

17. A method comprising:
obtaining a core structure having low permeability characteristics for an inductor,
wherein the core structure defines a first cross-sectional area;
obtaining one or more coil members; and
winding the one or more coil members around the core structure and forming one or more sets of loops,
wherein the one or more sets of loops each define a second cross-sectional area;
wherein the second cross-sectional area is between 1.2 to 5 times larger than the first cross-sectional area.

18. The method of claim 17, wherein winding the one or more coil members around the core structure comprises:
winding the one or more coil members around a portion of the core structure.

19. The method of claim 17, further comprising:
obtaining one or more frame members; and
positioning the one or more frame members around the core structure;
wherein the one or more coil members winds around a respective one of the one or more frame members to define the second cross-sectional area.

20. The method of claim 17, wherein the one or more coil members are further configured to provide an increase in inductance due to increased leakage paths for magnetic flux in response to increasing electrical current.
